(19) United States
(12) Patent Application Publication
(10) Pub. No.: US 2016/0278493 A1
(43) Pub. Date: Sep. 29, 2016

(54) ELECTRONIC APPARATUS CASE

(71) Applicant: Sharp Kabushiki Kaisha, Osaka (JP)

(72) Inventors: Mehdi SHIBAHARA, Osaka-shi (JP); Tomohisa YOSHIE, Osaka-shi (JP); Satoshi SHIBATA, Osaka-shi (JP); Ryohsuke YAMANAKA, Osaka-shi (JP)

(21) Appl. No.: 15/072,721

(22) Filed: Mar. 17, 2016

(30) Foreign Application Priority Data
Mar. 26, 2015 (JP) 2015-062557

(51) Int. Cl. A45C 11/00; H02S 30/10; A45F 5/00

(52) U.S. Cl. CPC A45C 11/00; A45F 5/00; H02S 30/10; A45C 2011/001; A45C 2011/002; A45C 2011/003

(57) ABSTRACT

An electronic apparatus case includes a holder holding an electronic apparatus and a cover covering a display. In the holder, when taking an x1y1z1 orthogonal coordinate system where a direction orthogonal to and away from the display surface is a z1 axis, and a direction parallel to a side of the display is a y1 axis. In the cover, when taking an x2y2z2 orthogonal coordinate system where a direction coinciding with the x1 axis is an x2 axis, and a direction orthogonal to the cover, and away from an inner surface of the cover is a z2 axis, the z1 axis coincides with the −z2 axis when the display is covered by the cover. The holder has a convex defining a rotation axis in the x1 axis direction and the cover has a track defining a gap extending in the y2 axis direction and storing the convex.

### BACKGROUND

1. Field

The present disclosure relates to a case and more particularly, to an electronic apparatus case. Moreover, in this specification, the electronic apparatus includes, for example, a mobile phone, a smart phone, a tablet PC, a portable game machine, a music player, an e-book terminal, an electronic dictionary, an electronic notebook, and the like.

2. Description of the Related Art

As electronic apparatuses have become more widespread, various electronic apparatus cases or covers have been developed. The electronic apparatus case (or cover) is, for example, intended to protect the electronic apparatus from impact or to avoid scratches of a display and/or a body of the electronic apparatus. Recently, a case or a cover having a function of not only protecting the electronic apparatus from impact or scratches but also charging the electronic apparatus has also been commercially available.

According to the study of the present inventors, in the multi-function housing case for a conventional smart phone, there is a problem that a space for opening and closing of a cover covering a display of the smart phone is large (Problem 1). Details of Problem 1 will be described below. Since the multi-function housing case for the conventional smart phone has Problem 1, for example, the case is not suitable for use in a crowded vehicle or in a crowd.

In addition, according to the study of the present inventors, in the notebook type e-book terminal case having a solar cell element, there is a problem that it is difficult to charge the e-book terminal while using the e-book terminal (Problem 2). In a case where the e-book terminal is used, for example, for easy holding (easy grip), a back cover and a front cover of the notebook type case are often superimposed. Otherwise, even if it is preferable that the e-book terminal is compact such as a case where the e-book terminal is used in the crowded vehicle or in the crowd, the e-book terminal can be used by superimposing the back cover and the front cover of the notebook type case. In such a case, since sunlight or illumination light is unlikely to be incident on the solar cell element provided in the front cover portion, it is difficult to charge the e-book terminal.

### SUMMARY

The present disclosure is made in order to deal with Problem 1 described above and it is desirable to provide an electronic apparatus case in which opening and closing of a cover covering a display of an electronic apparatus can be performed compactly and quickly.

According to an aspect of the disclosure, there is provided an electronic apparatus case including a holder that holds an electronic apparatus; and a cover that includes a sheet-shaped cover covering a display surface of the electronic apparatus. In the holder, when taking an x1y1z1 orthogonal coordinate system in which a direction that is orthogonal to the display surface of the electronic apparatus held in the holder and away from the display surface is a z1 axis, a direction that is orthogonal to the z1 axis and parallel to a side of the display surface is a y1 axis, and a direction that is orthogonal to the y1 axis and the z1 axis is an x1 axis, and in the cover, when taking an x2y2z2 orthogonal coordinate system in which a direction that coincides with the x1 axis is an x2 axis, a direction that is orthogonal to the x2 axis and the cover, and away from an inner surface of the cover is a z2 axis, and a direction that is orthogonal to the x2 axis and the z2 axis is a y2 axis, in a first state in which the display surface is covered by the cover, the z1 axis coincides with a −z2 axis. The holder has a pair of side surface members that are provided parallel to a y1-z1 plane and a convex portion that is provided in each of the pair of the side surface members and defines a rotation axis in the x1 axis direction. The cover has a pair of lateral frame members that are provided parallel to a y2-z2 plane and a track that is provided in each of the pair of the lateral frame members, defines a gap extending in the y2 axis direction, and receives the convex portion.

### BRIEF DESCRIPTION OF THE DRAWINGS

FIG. 1 is a view schematically illustrating an electronic apparatus case of Embodiment 1 according to the disclosure;

FIG. 2 is a view schematically illustrating a transition between a first state and a second state of the electronic apparatus case of Embodiment 1 according to the disclosure;

FIG. 3 is a view schematically illustrating an example of a transition from the first state to the second state of the electronic apparatus case of Embodiment 1 according to the disclosure;

FIG. 4 is a plan view of the electronic apparatus case of Embodiment 1 according to the disclosure when viewed in an x1 axis direction and is an enlarged view illustrating a vicinity of a convex portion and a rotation axis;

FIG. 5 is a view schematically illustrating an electronic apparatus case of Embodiment 1 according to the disclosure;

FIG. 6 is a view schematically illustrating an electronic apparatus case of Embodiment 2 according to the disclosure;

FIG. 7 is a plan view of a holder of the electronic apparatus case of Embodiment 2 according to the disclosure when viewed in a z1 axis direction and is an enlarged view illustrating a vicinity of a convex portion and a rotation axis;

FIG. 8 is a view schematically illustrating an electronic apparatus case of Embodiment 3 according to the disclosure;

An upper left of FIG. 9 is a schematic plan view of a cover of the electronic apparatus case of Embodiment 3 according to the disclosure when viewed in a z2 axis direction, the upper right thereof is a schematic plan view of the cover of the electronic apparatus case of Embodiment 3 according to the disclosure when viewed in a −z2 axis direction, the lower left thereof is a schematic plan view of a holder of the electronic apparatus case of Embodiment 3 according to the disclosure when viewed in a z1 axis direction, and the lower right thereof is a schematic plan view of the holder of the electronic apparatus case of Embodiment 3 according to the disclosure when viewed in a −z1 axis direction;

FIG. 10 is a view schematically illustrating an electronic apparatus case of Embodiment 3 according to the disclosure;

FIG. 11 is a view schematically illustrating an example of a configuration of first to third terminals in the electronic apparatus case of Embodiment 3 according to the disclosure;

FIG. 12 is a view schematically illustrating an electronic apparatus case of Embodiment 4 according to the disclosure;

FIG. 13 is a view schematically illustrating an electronic apparatus case of Embodiment 4 according to the disclosure;

FIG. 14 is a view schematically illustrating an electronic apparatus case of Embodiment 4 according to the disclosure;

FIG. 15 is a view schematically illustrating an electronic apparatus case of a comparative example;

FIG. 16 is a view schematically illustrating a transition between a first state and a second state of the electronic apparatus case of the comparative example; and

FIG. 17 is a view schematically illustrating an example of a transition from the first state to the second state of the electronic apparatus case of the comparative example.

### DESCRIPTION OF THE EMBODIMENTS

Hereinafter, forms according to embodiments of the disclosure will be described with reference to the drawings. Moreover, the disclosure is not limited to the embodiments exemplified below. In the following drawings, the same reference numerals are given to configuration elements having substantially the same function and description thereof will be omitted.

### Embodiment 1

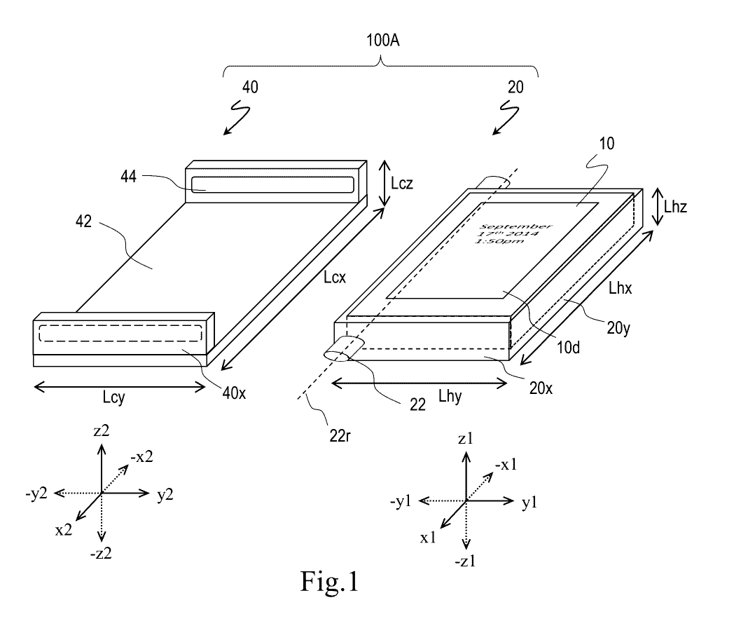

An electronic apparatus case 100A of Embodiment 1 according to the disclosure will be described with reference to FIGS. 1 to 3. FIG. 1 is a view schematically illustrating an electronic apparatus case 100A.

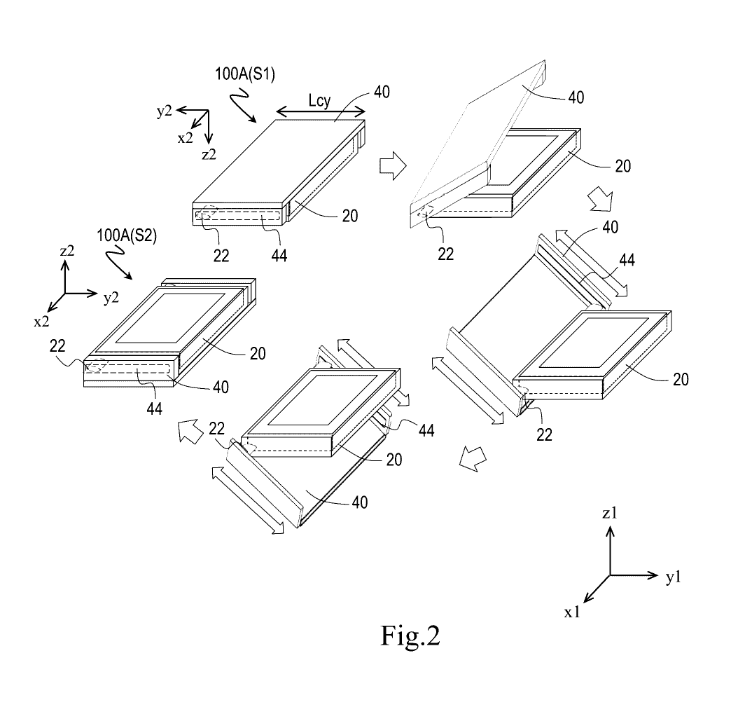

The electronic apparatus case 100A includes a holder 20 that holds an electronic and a cover 40 including a sheet-shaped cover 42 that covers a display surface 10d of the electronic apparatus 10. In the holder 20, an x1y1z1 orthogonal coordinate system, in which a direction that is orthogonal to the display surface 10d of the electronic apparatus 10 held in the holder 20 and away from the display surface 10d is a z1 axis, a direction that is orthogonal to the z1 axis and parallel to one side of the display surface 10d is a y1 axis, and a direction that is orthogonal to the y1 axis and the z1 axis is an x1 axis, is taken. In the cover 40, an x2y2z2 orthogonal coordinate system, in which a direction that coincides with the x1 axis is an x2 axis, a direction that is orthogonal to the x2 axis and the cover 42, and away from an inner surface of the cover 42 is a z2 axis, and a direction that is orthogonal to the x2 axis and the z2 axis is a y2 axis, is taken. In a first state (see the upper left view of FIG. 2) in which the display surface 10d is covered by the cover 42, the z1 axis coincides with a −z2 axis. The holder 20 has a pair of side surface members 20x that are provided parallel to a y1-z1 plane and a convex portion 22 that is provided in each of the pair of the side surface members 20x and defines a rotation axis 22r in the x1 axis direction. The cover 40 has a pair of the lateral frame members 40x that are provided parallel to a y2-z2 plane and a track 44 that is provided in each of the pair of the lateral frame members 40x, defines a gap extending in a y2 axis direction, and receives the convex portion 22.

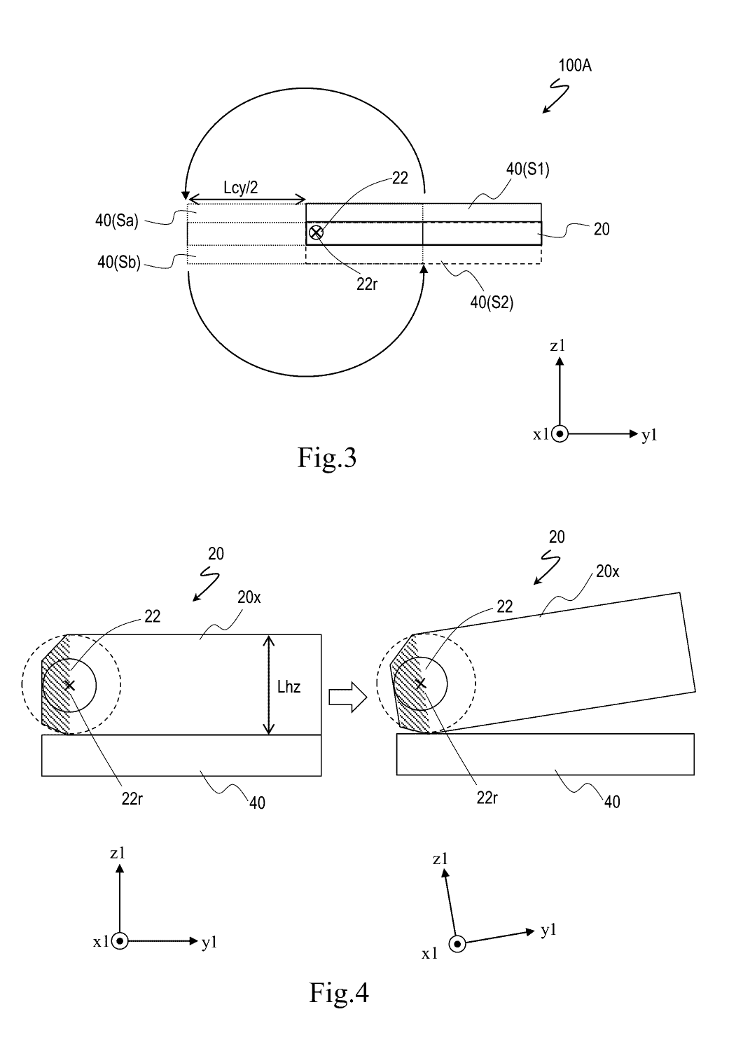

In the electronic apparatus case 100A, the cover 40 slides with respect to the holder 20 along the track 44 and rotates around the rotation axis 22r. As illustrated in FIGS. 2 and 3, the electronic apparatus case 100A can perform opening and closing of the cover that covers the display of the electronic apparatus compactly and quickly.

Moreover, the x1y1z1 orthogonal coordinate system is a right-handed orthogonal coordinate system. In FIG. 1, a −x1 axis, a −y1 axis, and a −z1 axis are also displayed in addition to the x1 axis, the y1 axis, and the z1 axis defining the x1y1z1 orthogonal coordinate system. In the present specification, the −x1 axis refers to an axis of which a direction is opposite to the x1 axis direction. Similarly, the −y1 axis refers to an axis of which a direction is opposite to the y1 axis direction. The −z1 axis refers to an axis of which a direction is opposite to the z1 axis direction. In other views, the −x1 axis, the −y1 axis, and the −z1 axis may be omitted. The same applies to the x2y2z2 orthogonal coordinate system.

Typically, the display surface 10d of the electronic apparatus 10 refers to a surface including a main display of the electronic apparatus 10. In a case where the electronic apparatus has the displays in a plurality of surfaces, for example, a surface, in which a total area of the display that is included is large, is referred to as the display surface. The disclosure is not limited to the example and a surface that particularly needs protecting by the cover may be the display surface. A shape of the display is not limited to a rectangular shape illustrated in FIG. 1 and, for example, may be an arbitrary shape such as a circular shape and an elliptical shape.

The holder 20 holds the electronic apparatus 10 in a state of exposing the display surface 10d of the electronic apparatus 10. The pair of the side surface members (first side surface members) 20x provided parallel to the y1-z1 plane covers surfaces of the electronic apparatus 10, which is, for example, held by the holder 20, parallel to the y1-z1 plane. The pair of the side surface members 20x may completely cover the surfaces of the electronic apparatus 10, which is held by the holder 20, parallel to the y1-z1 plane or may cover only a part thereof. For example, the pair of the side surface members 20x may be members holding the surfaces along sides that form surfaces of the electronic apparatus 10, which is held by the holder 20, parallel to the y1-z1 plane.

The holder 20 may further have a pair of side surface members (second side surface members) 20y provided parallel to the x1-y1 plane. The second side surface members 20y cover surfaces of the electronic apparatus 10, which is held by the holder 20, parallel to the x1-z1 plane. Similar to the first side surface members 20x, the second side surface members 20y may completely cover the surfaces of the electronic apparatus 10, which is held by the holder 20, parallel to the x1-z1 plane, may cover only a part thereof, or may hold the surfaces along sides forming surfaces of the electronic apparatus 10, parallel to the x1-z1 plane. The holder 20 may further have, for example, a rear surface member 20b (see FIG. 9) provided parallel to the x1-y1 plane. The rear surface member of the holder 20 covers, for example, a rear surface 10b (see FIG. 9) on a side opposite to the display surface 10d. similar to the first and second side surface members 20x and 20y, the rear surface member of the holder 20 may completely cover the rear surface on the side opposite to the display surface 10d, may cover only a part thereof, or may hold the surface along sides forming the rear surface on the side opposite to the display surface 10d.

Typically, the convex portion 22 is a cylindrical shape. The convex portion 22 may be, for example, a truncated cone shape. The convex portion 22 may be, for example, a square column or an elliptical column, but it is preferable that the convex portion 22 is the cylindrical shape for ease of rotation.

The cover 40 has the track 44 that is a recessed groove. In this case, a gap in the y2-z2 plane defined by the track 44 does not penetrate in the x2 axis direction. The gap defined by the track 44 may penetrate in the x2 axis direction. The gap penetrating in the x2 axis direction is defined by, for example, the track 44 (see FIG. 10) that is a substantially elliptical-shaped rail. In this case, the pair of the lateral frame members 40x provided parallel to the y2-z2 plane include the substantially elliptical-shaped rails. As described above, the pair of the lateral frame members 40x are not limited to the sheet shape parallel to the y2-z2 plane and may penetrate in the x2 axis direction.

A length of the gap defined by the track 44 in the y2 axis direction is substantially equal to, for example, a length of the cover 40 in the y2 axis direction. The length of the gap defined by the track 44 in the y2 axis direction may be shorter than the length of the cover 40 in the y2 axis direction. For example, as illustrated in FIG. 1, both ends of the track 44 in the y2 axis direction are closed in the lateral frame member 40x.

A length Lhy of the holder 20 in the y1 axis direction is substantially equal to, for example, a length Lcy of the cover 40 in the y2 axis direction. A length Lhx of the holder 20 in the x1 axis direction substantially coincides with, for example, a length that is obtained by excluding two times the length of each of the lateral frame members 40x in the x2 axis direction from a length Lcx of the cover 40 in the x2 axis direction. Here, the length Lhx of the holder 20 in the x1 axis direction does not include a length of the convex portion 22 in the x1 axis direction. A length (thickness) Lhz of the holder 20 in the z1 axis direction substantially coincides with, for example, a length that is obtained by excluding a length of the cover 42 in the z2 axis direction from a length (thickness) Lcz of the cover 40 in the z2 axis direction.

The length Lcy of the cover 40 in the y2 axis direction is, for example, shorter than the length Lcx of the cover 40 in the x2 axis direction. The length Lcy of the cover 40 in the y2 axis direction may be longer than the length Lcx of the cover 40 in the x2 axis direction. However, as described below, if the length Lcy of the cover 40 in the y2 axis direction is short, it is possible to perform opening and closing of the cover covering the display further compactly and quickly.

The holder 20 and the cover 40 are formed of, for example, the same material. The holder 20 and the cover 40 can be formed of, for example, a resin material (for example, ABS resin, PP resin, PE resin, PC resin, PMMA resin, silicone rubber, and thermoplastic polyurethane (TPU) resin) or a metal material (for example, an aluminum alloy, a magnesium alloy, and stainless steel). The holder 20 and the cover 40 may be formed of different materials. The holder 20 and/or the cover 40 formed of the resin material is manufactured by molding (for example, injection molding or insert molding). The holder 20 and/or the cover 40 formed of the metal material, can be manufactured by for example, pressing, cutting, molding, and the like. It is possible to cover the holder 20 and/or the cover 40 manufactured by the method described above with leather or fabric, for example, to improve aesthetics and/or to improve a protection function of the electronic apparatus.

FIG. 2 is a perspective view schematically illustrating a transition between a first state 100A (S1) of the electronic apparatus case 100A and a second state 100A (S2) of the electronic apparatus case 100A.

In FIG. 2, the upper left illustrates the first state 100A (S1) of the electronic apparatus case 100A and the lower left illustrates the second state 100A (S2) of the electronic apparatus case 100A. In FIG. 2, for the sake of easy understanding, the holder 20 is fixed and rotation and sliding of the cover 40 with respect to the holder 20 are illustrated. The same is applied to the following description unless otherwise stated. Accordingly, in FIG. 2, the x1y1z1 coordinate axis of the holder 20 does not change. The x2y2z2 coordinate axis of the cover 40 is illustrated only in the first state and the second state, and is omitted in other states. When using the electronic apparatus case 100A, of course, it is not limited to the example illustrated in FIG. 2, the cover 40 is fixed and the holder 20 may be rotated and/or slid, or both the holder 20 and the cover 40 may be rotated and/or slid.

In the first state 100A (S1), the display surface 10d is covered by the cover 42 and thereby the display surface 10d is protected. In the first state, the z1 axis coincides with the −z2 axis. That is, in the first state, the display surface 10d and the cover 42 are parallel to each other. The first state 100A (S1) is typically a state where the electronic apparatus 10 is not used. In the second state 100A (S2), a rear surface facing the display surface 10d of the electronic apparatus 10 is covered by the cover 42 and thereby the display surface 10d is exposed. In the second state, for example, the z1 axis coincides with the z2 axis. For example, the display surface 10d and the rear surface facing the display surface 10d are parallel to each other and in the second state, the display surface 10d, the rear surface, and the cover 42 may be parallel to each other. The second state 100A (S2) is typically a state where the electronic apparatus 10 is used. For example, when starting use of the electronic apparatus and finishing the use thereof, the first state and the second state are switched.

In a process of transition from the first state to the second state, the cover 40 is rotated with respect to the holder 20 and the cover 40 is slid with respect to the holder 20. The order of the rotation and the sliding does not matter. It may be slid after the rotation or it may be rotated after the sliding. For example, from the first state, after the cover 40 is rotated around the rotation axis 22r by 180°, the cover 40 is slid in the y2 axis direction by the length Lcy of the cover 40 in the y2 axis direction and thereby it is possible to move on to the second state. For the sake of simplicity, a length of the gap defined by the track 44 in the y2 axis direction is equal to the length Lcy of the cover 40 in the y2 axis direction. In addition, the order of the rotation and the sliding may be reversed. That is, from the first state, after the cover 40 is slid by the length Lcy of the cover 40 in the y2 axis direction, the cover 40 is rotated around the rotation axis 22r by 180° and thereby it is possible to lead to the second state.

In the electronic apparatus case 100A, it is also possible to perform the rotation and/or the sliding alternately by dividing the rotation and/or the sliding. It is also possible to perform the rotation and the sliding simultaneously. An example will be described with reference to FIG. 3. In this case, in the process of changing from the first state to the second state, a total distance in which the cover 40 is slid in the y2 axis direction is the length Lcy of the cover 40 in the y2 axis direction and a total angle in which the cover 40 is rotated around the rotation axis 22r may be substantially 180°.

That is, a case where the cover 40 can be rotated with respect to the holder 20 includes not only a case where the rotation axis 22r is positioned in an end of the track 44 in the y2 axis direction or an end thereof in the −y2 axis direction, but also a case where the rotation axis 22r is positioned at an intermediate point of the track 44. A state where the cover 40 is slid with respect to the holder 20 includes not only a state where the z1 axis coincides with the −z2 axis or the z1 axis coincides with the z2 axis, but also a state where the z1 axis is inclined with respect to the z2 axis or the −z2 axis (state where the display surface 10d is inclined with respect to the cover 42).

As described above, the electronic apparatus case 100A has a high degree of freedom in the process of transition from the first state to the second state. This is because the convex portion 22 defining the rotation axis 22r is provided in the holder 20. The electronic apparatus case 100A can also be suitably used in the crowded vehicle, in the crowd, and the like.

A case where the electronic apparatus case 100A can perform opening and closing of the cover covering the display compactly and quickly will be described with reference to FIG. 3. FIG. 3 schematically illustrates an example of a transition from the first state to the second state of the electronic apparatus case 100A. FIG. 3 is a plan view of the electronic apparatus case 100A viewed in the x1 axis direction. Since the x1 axis and the x2 axis are parallel to each other, the plan view of the electronic apparatus case 100A viewed in the x1 axis direction coincides with a plan view of the electronic apparatus case 100A viewed in the x2 axis direction. In FIG. 3, the x1y1z1 coordinate axis of the holder 20 is illustrated and the x2y2z2 coordinate axis of the cover 40 is omitted.

As illustrated in FIG. 3, as an example of transition between the first state and the second state, the following process can be considered. A process, which is transited from the first state to the second state by further sliding the cover 40 in the y2 axis direction by Lcy/2 from a state b via a state a that is obtained by sliding the cover 40 in the y2 axis direction by half (Lcy/2) of the length of the cover 40 in the y2 axis direction and the state b that is obtained by rotating the cover 40 around the rotation axis 22r from the state a by 180°, is considered.

Here, in FIG. 3, the cover is represented in each state by denoting a symbol in parentheses at the end of the reference numeral of the cover. For example, a cover 40(S1) represents the cover 40 in the first state and a cover 40(S2) represents the cover 40 in the second state. A cover 40(Sa) and a cover 40(Sb) represent the cover 40 in the state a and the state b respectively. The cover 40(S1) is represented by a solid line, the cover 40(Sa) and the cover 40(Sb) are represented by a dotted line, and the cover 40(S2) is represented by a dashed line. The rotation axis 22r is represented by intersection of “x”.

In the process, an area through which the cover 40 passes in the y1-z1 plane (or y2-z2 plane) is substantially the same as an area of a circle of which a radius is Lcy/2, that is, substantially πLcy²/4. Moreover, here, for the sake of simplicity, a length Lcz of the cover 40 in the z2 axis direction is not taken into consideration and the rotation axis 22r is in the end of the holder 20 in the −y1 axis direction. These assumptions do not considerably affect evaluation of the area in a case where the length Lcz of the cover 40 in the y2 axis direction is sufficiently smaller than the length Lcy of the cover 40 in the y2 axis direction and in a case where a distance from the rotation axis 22r to the end of the holder 20 in the −y1 axis direction is sufficiently smaller than the length Lcy of the cover 40 in the y2 axis direction. In similar assumptions, in the process described above, a distance in which a certain point in the cover 40 moves is evaluated. A distance, in which one point of the end of the cover 40 in the y2 axis direction moves in the y1-z1 plane (or y2-z2 plane), is a sum (Lcy(π/2+1)) of the radius Lcy/2, a length πLcy/2 of the arc of a center angle of 180°, and the length Lcy of the cover 40 in the y2 axis direction.

As described above, in the electronic apparatus case of Embodiment 1, a space for opening and closing of the cover covering the display of the electronic apparatus is smaller than that in an electronic apparatus case of a comparative example. The distance in which the cover moves in opening and closing of the cover is also smaller than that in the electronic apparatus case of the comparative example. In the electronic apparatus case of Embodiment 1, opening and closing of the cover covering the display can be performed compactly and quickly. The electronic apparatus case of Embodiment 1 can deal with Problem 1 described above. According to the estimation described above, the space for opening and closing of the cover is substantially 0.5 in the electronic apparatus case of Embodiment 1 when the space is 1 in the electronic apparatus case of the comparative example. The distance in which the cover moves in opening and closing of the cover is substantially 0.6 in the electronic apparatus case of Embodiment 1 when the distance is 1 in the electronic apparatus case of the comparative example.

As described above with reference to FIG. 3, since the area through which the cover 40 passes in the y1-z1 plane is substantially proportional to a square of the length Lcy of the cover 40 in the y2 axis direction, if the length of the cover 40 in the y2 axis direction is short, it is possible to perform opening and closing of the cover covering the display more compactly and quickly. If it is desired to increase the effects in which opening and closing of the cover is performed compactly and quickly, a short side of the display surface of the electronic apparatus may be in a direction parallel to the y1 axis.

A process of transition from the second state to the first state is performed by reversing the process of the transition from the first state to the second state. The order of the rotation and the sliding may also be changed in the process that is performed by reversing the process of the transition from the first state to the second state. Also here, in the process of changing from the second state to the first state, a total distance in which the cover 40 is slid in the −y2 axis direction is the length Lcy of the cover 40 in the y2 axis direction, a total angle in which the cover 40 is rotated around the rotation axis 22r may be substantially 180°, and the sliding and the rotation may be performed simultaneously. The direction in which the cover 40 is slid and the direction in which the cover 40 is rotated are opposite to those of the process of the transition from the first state to the second state.

A structure of the first side surface member 20x of the holder 20 will be described in detail with reference to FIG. 4. FIG. 4 is a plan view of the electronic apparatus case 100A when viewed in the x1 axis direction and is an enlarged view illustrating the vicinity of the convex portion 22 and the rotation axis 22r of the first side surface member 20x. For the sake of easiness of viewing, in FIG. 4, a portion of the lateral frame member 40x of the cover 40 overlapping the holder 20 when viewed in the x1 axis direction is omitted. A left view of FIG. 4 is the first state and a right view of FIG. 4 is a state where the cover 40 is rotated around the rotation axis 22r from the first state. In FIG. 4, the cover 40 is fixed and the holder 20 is rotated with respect to the cover 40.

As illustrated in FIG. 4, in the y1-z1 plane of the first side surface member 20x, for a certain point of which a y1 coordinate is positioned between the rotation axis 22r and an end (end of the holder 20 in the −y1 axis direction in the example of FIG. 4) among an end in the y1 axis direction of the holder 20 and an end in a −y1 axis direction of the holder 20, which is close to the rotation axis 22r, a distance from the rotation axis 22r is equal to or less than half the length Lhz of the holder 20 in the z1 axis direction. In FIG. 4, a circle of which a radius is Lhz/2 around the rotation axis 22r is represented by a dashed line. In FIG. 4, a hatched portion represents a range in which the y1 coordinate is present between the rotation axis 22r and the end of the holder 20 in the −y1 axis direction. As illustrated in FIG. 4, the range represented by hatched lines is in a circle represented by a dashed line. The holder 20 and the cover 40 do not collide with each other and the holder 20 can be rotated with respect to the cover 40 by providing such a structure. Moreover, such a structure of the holder 20 is omitted in other views. The y1 coordinate of the rotation axis 22r is not limited to the example of FIG. 4 and may be close to the end of the holder 20 in the y1 axis direction among the end of the holder 20 in the y1 axis direction and the end of the holder 20 in the −y1 axis direction.

For the holder 20 illustrated in FIG. 4, for example, the holder 20 is formed substantially in a rectangular shape in the y1-z1 plane and then corners of the rectangular shape may be cut so as to enter the circle of FIG. 4. It is possible to manufacture the holder 20 having the structure illustrated in FIG. 4 by the molding (for example, injection molding or insert molding) or pressing. As illustrated in FIG. 4, as the y1 coordinate of the rotation axis 22r is closer to one end in the end of the holder 20 in the y1 axis direction and the end of the holder 20 in the −y1 axis direction, a cutting amount may be reduced.

In the electronic apparatus case of Embodiment 1, for example, as illustrated in FIGS. 3 and 4, the convex portion 22 completely overlaps the holder 20 when viewing the holder 20 from the x1 axis direction. As illustrated in FIG. 3, when viewing the holder 20 in the x1 axis direction, in the y1 coordinate, the end of the convex portion 22 may be on the inner side than the end of the holder 20. As illustrated in FIG. 4, in the first side surface member 20x, the end of the convex portion 22 in the −y1 axis direction may coincide with the end of the holder 20 in the −y1 axis direction. In addition, in the electronic apparatus case of Embodiment 1, for example, as illustrated in FIGS. 3 and 4, when viewing the holder 20 from the x1 axis direction, the rotation axis 22r overlaps the holder 20 and the electronic apparatus 10 held in the holder 20. The electronic apparatus case of Embodiment 1 is not limited to the example.

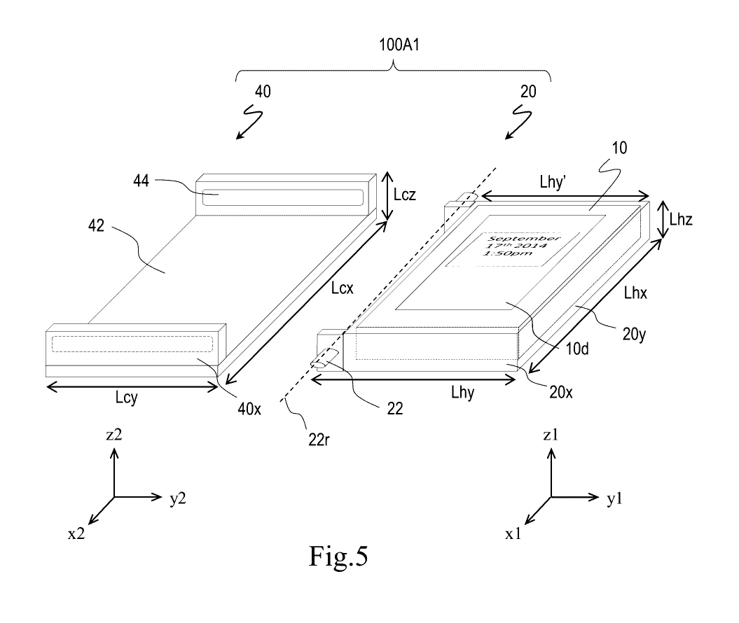

FIG. 5 schematically illustrates an electronic apparatus case 100A1 of Embodiment 1. The electronic apparatus case 100A1 is different from the electronic apparatus case 100A in the positions of the convex portion 22 and the rotation axis 22r. The electronic apparatus case 100A1 may be the same as the electronic apparatus case 100A except for the positions of the convex portion 22 and the rotation axis 22r.

As illustrated in FIG. 5, in the electronic apparatus case 100A1, when viewing the holder 20 from the x1 axis direction, the rotation axis 22r does not overlap the electronic apparatus 10 held in the holder 20. In this case, the length Lhy of the holder 20 in the y1 axis direction may be longer than the length of the cover 40 in the y2 axis direction. A length Lhy′ in the y1 axis direction in a cross section (cross section of a portion in which the first side surface member 20x is not provided), in which the convex portion 22 is not provided in a cross section of the holder 20 parallel to the y1-z1 plane, is shorter than the length Lhy of the holder 20 in the y1 axis direction. In the electronic apparatus case 100A1, when rotating the holder 20 with respect to the cover 40, a space between the holder 20 and the cover 40 is wider than that of the electronic apparatus case 100A. Accordingly, it is possible to more smoothly rotate the holder 20 and to perform opening and closing of the cover covering the display of the electronic apparatus more quickly. Furthermore, even if a first terminal 51 described below with reference to FIG. 9 is provided, smoothness of opening and closing of the cover is unlikely to be impaired. Detailed description will be described later.

### Embodiment 2

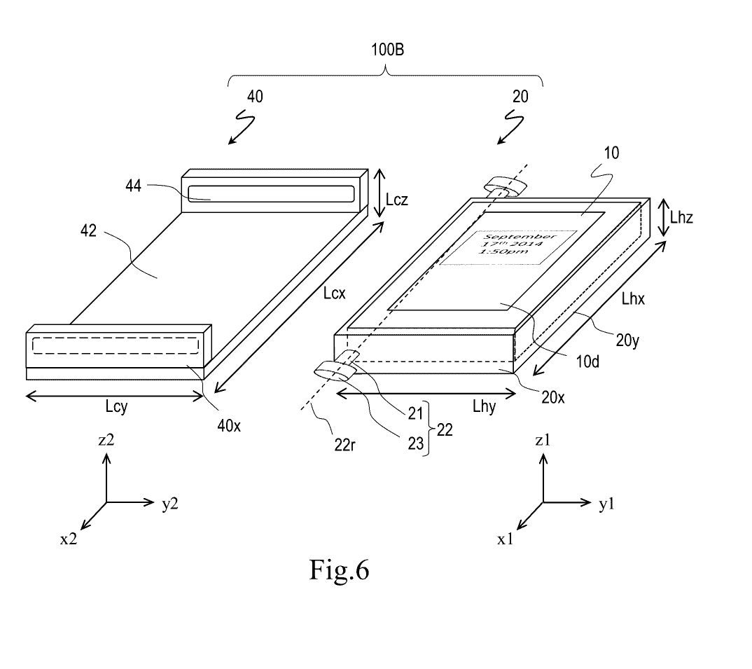

An electronic apparatus case 100B of Embodiment 2 according to the disclosure will be described with reference to FIG. 6. FIG. 6 is a view schematically illustrating the electronic apparatus case 100B. Hereinafter, in the electronic apparatus case 100B of the embodiment, points different from the electronic apparatus case of Embodiment 1 are mainly described. The same applies to the following embodiments.

In the electronic apparatus case 100B, a convex portion 22 has a main portion 21 and a fitting portion 23 that is fitted into a track 44. An area of a cross section of the fitting portion 23 parallel to the y1-z1 plane is greater than an area of a cross section of the main portion 21 parallel to the y1-z1 plane.

In the electronic apparatus case 100B, a cover 40 is slid with respect to a holder 20 along the track 44 and is rotated around a rotation axis 22r. Similar to the electronic apparatus case 100A, the electronic apparatus case 100B can perform opening and closing of the cover covering a display of an electronic apparatus compactly and quickly. The electronic apparatus case 100B can deal with Problem 1 described above.

Since the convex portion 22 of the electronic apparatus case 100B has the fitting portion 23, it is possible to suppress the convex portion 22 being removed from the track 44. The holder 20 can be more smoothly slid with respect to the cover 40. Accordingly, it is possible to perform opening and closing of the cover covering the display of the electronic apparatus more compactly and quickly.

A cross section of the fitting portion 23 parallel to the y1-z1 plane is, for example, a circle. A shape of the cross section of the fitting portion 23 parallel to the y1-z1 plane is not limited to the embodiment and it is preferable to be a circular shape in view of smooth rotation. In a case where the fitting portion 23 and the convex portion 22 are integrally formed, it is particularly preferable to be the circular shape. In a case where the main portion 21 can be rotated around the rotation axis 22r with respect to the fitting portion 23, it is not limited to the circular shape and, for example, may be elliptical or rectangular. In any case, it is preferable that a length of the fitting portion 23 in the z1 axis direction substantially coincides with, for example, a length of a gap defined by the track 44 in the z2 axis direction.

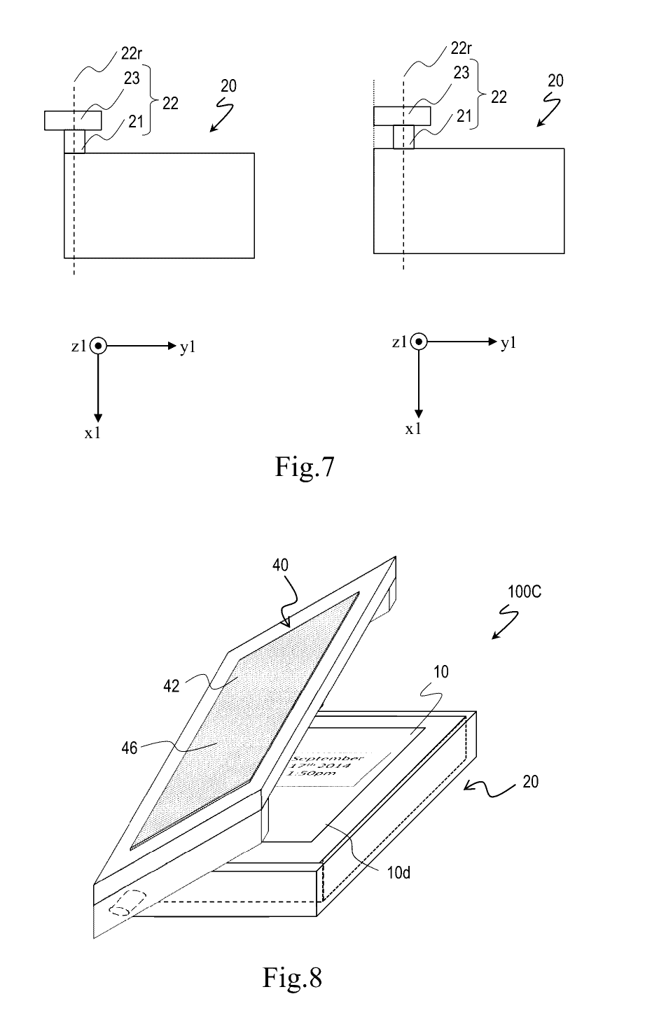

As described in Embodiment 1, the positions of the convex portion 22 and the rotation axis 22r are not limited to those illustrated in the examples. An example of the positions of the convex portion 22 and the rotation axis 22r will be described with reference to FIG. 7. FIG. 7 schematically illustrates an example of a plan view of the holder 20 of the electronic apparatus case 100B of Embodiment 2 when viewed in the z1 axis direction. FIG. 7 is an enlarged view illustrating a vicinity of the convex portion 22 and the rotation axis 22r.

As illustrated in a right view and a left view of FIG. 7, the rotation axis 22r overlaps, for example, the holder 20 and the electronic apparatus 10 held in the holder 20 when viewing the holder 20 in the x1 axis direction.

As illustrated in the right view of FIG. 7, for example, the end of the fitting portion 23 in the −y1 axis direction may coincide with the end of the holder 20 in the −y1 axis direction when viewing the holder 20 in the x1 axis direction. Otherwise, as illustrated in the left view of FIG. 7, for example, the end of the main portion 21 in the −y1 axis direction may coincide with the end of the holder 20 in the −y1 axis direction when viewing the holder 20 in the x1 axis direction.

As illustrated in the left view of FIG. 7, the end of the fitting portion 23 in the −y1 axis direction may be on the outer side than the end of the holder 20 in the −y1 axis direction when viewing the holder 20 in the x1 axis direction, that is, in the first side surface member 20x. If the end of the fitting portion 23 in the −y1 axis direction is on the outer side than the end of the holder 20 in the −y1 axis direction, when rotating the holder 20 with respect to the cover 40, the space between the holder 20 and the cover 40 is wide. Accordingly, it is possible to more smoothly rotate the holder 20 and to perform opening and closing of the cover covering the display of the electronic apparatus more quickly. Furthermore, even if the first terminal 51 described below with reference to FIG. 9 is provided, smoothness of opening and closing of the cover is unlikely to be impaired. Detailed description will be described later.

Moreover, the y1 coordinate of the rotation axis 22r is not limited to the example of FIG. 7 and, of course, may be closer to the end of the holder 20 in the y1 axis direction among the end of the holder 20 in the y1 axis direction and the end of the holder 20 in the −y1 axis direction. In this case, a relationship between the end of the main portion 21 in the −y1 axis direction or the end of the fitting portion 23 in the −y1 axis direction and the end of the holder 20 in the −y1 axis direction as described above with reference to FIG. 7 is applied to a relationship between the end of the main portion 21 in the y1 axis direction or the end of the fitting portion 23 in the y1 axis direction and the end of the holder 20 in the y1 axis direction.

In addition, as described in the electronic apparatus case 100A1 of Embodiment 1 with reference to FIG. 5, also in Embodiment 2, the rotation axis 22r can also have a structure not to overlap the electronic apparatus 10 held in the holder 20 when viewing the holder 20 in the x1 axis direction. If such a structure is provided, when rotating the holder 20 with respect to the cover 40, since the space between the holder 20 and the cover 40 is wide, it is possible to more smoothly rotate the holder 20 and to perform opening and closing of the cover covering the display of the electronic apparatus more quickly. Furthermore, even if the first terminal 51 described below with reference to FIG. 9 is provided, smoothness of opening and closing of the cover is unlikely to be impaired. Detailed description will be described later.

### Embodiment 3

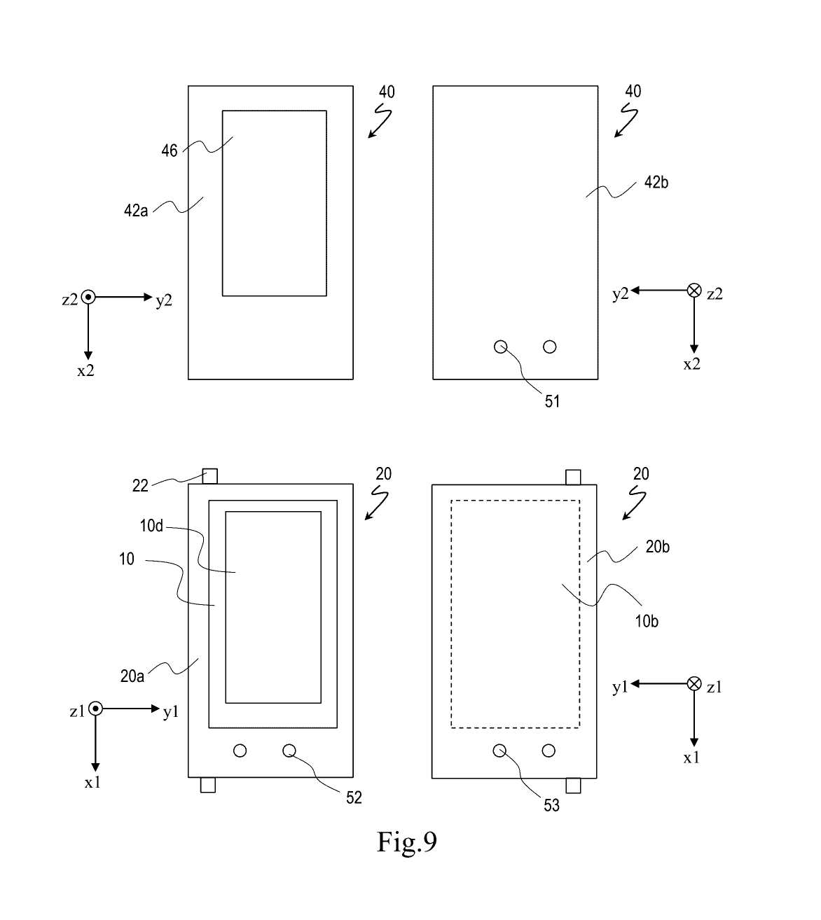

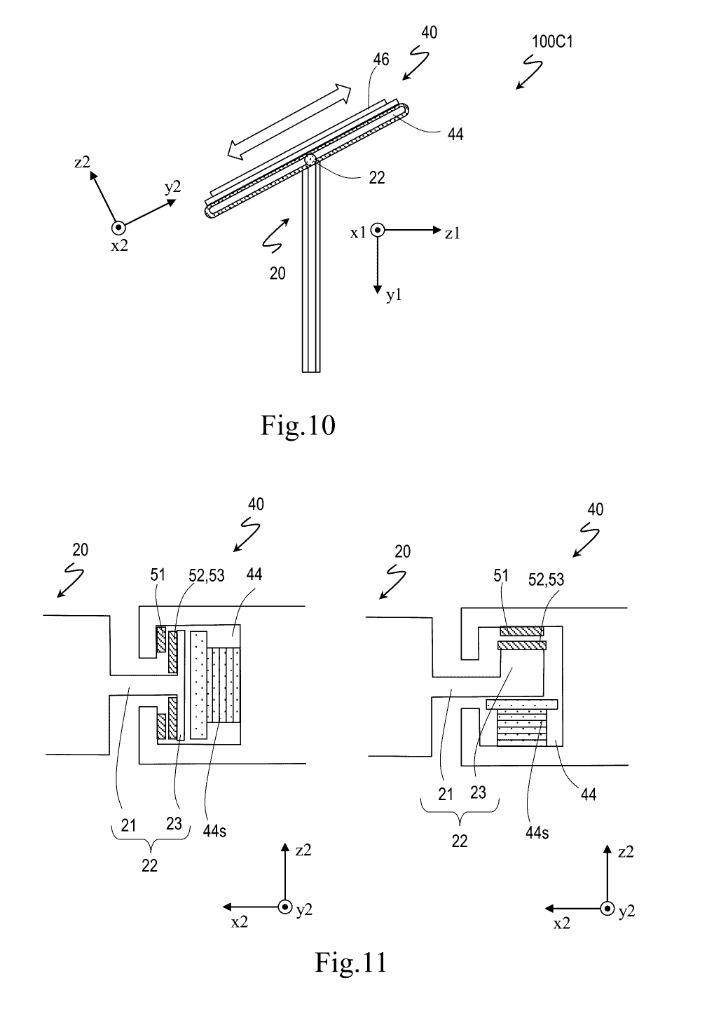

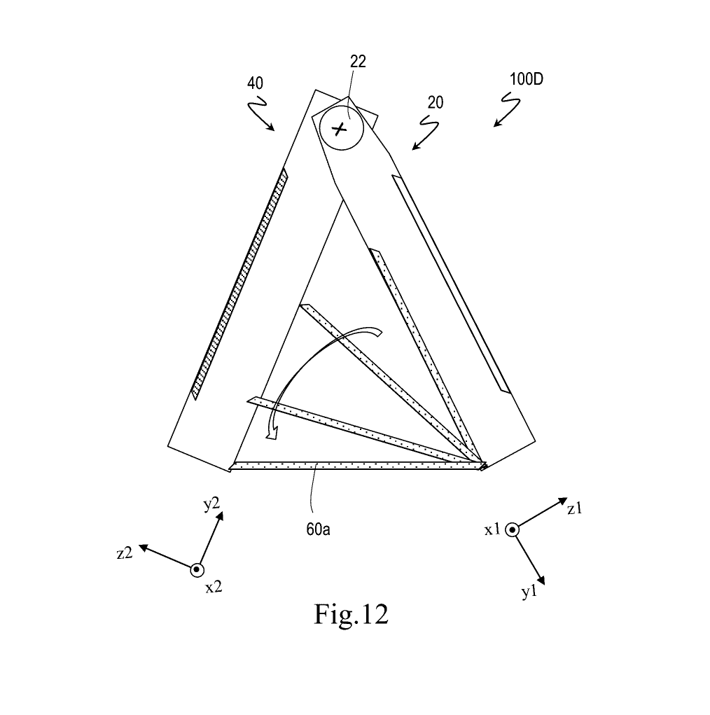

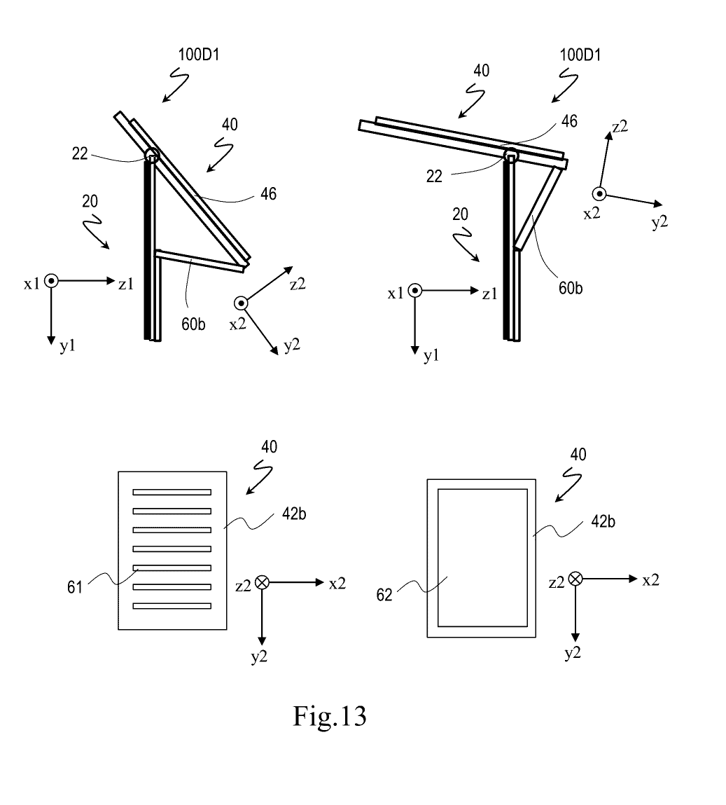

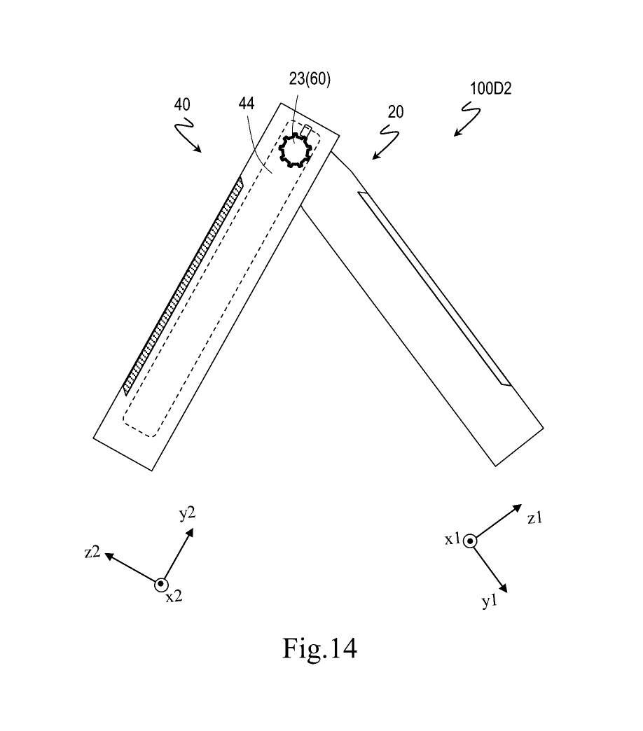

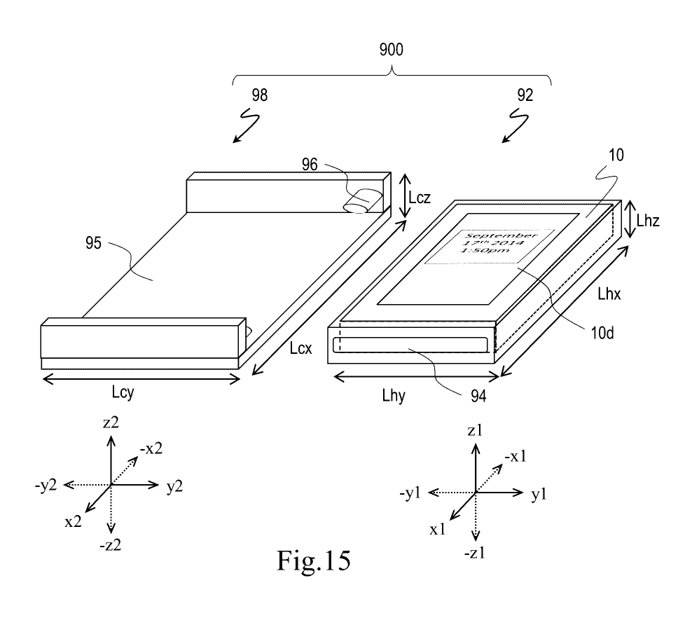

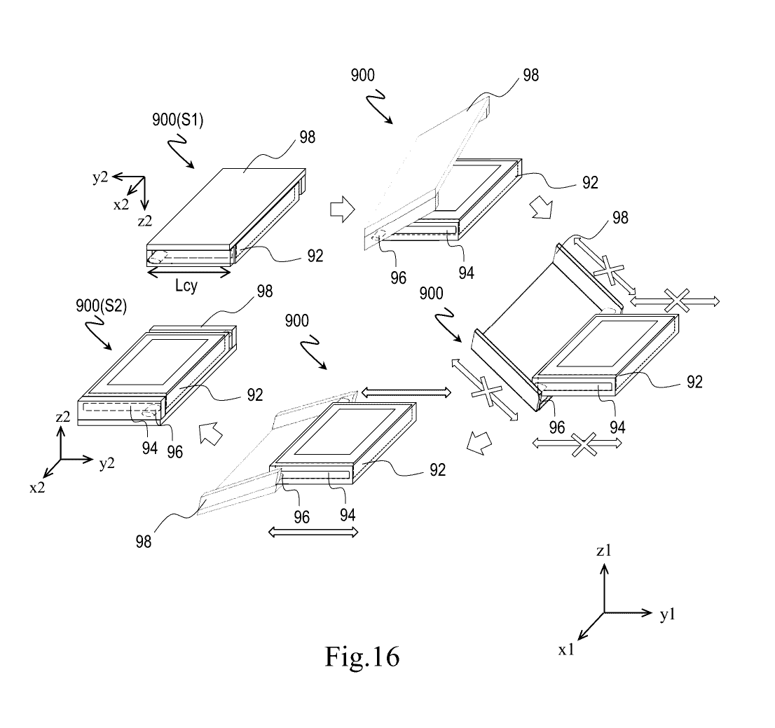

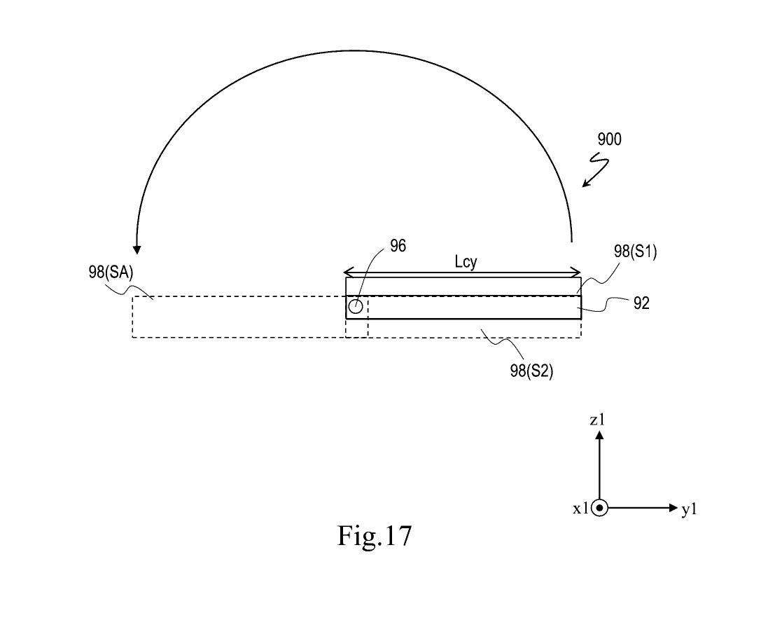

An electronic apparatus case 100C of Embodiment 3 according to the disclosure will be described with reference to FIG. 8. FIG. 8 is a view schematically illustrating the electronic apparatus case 100C.

As illustrated in FIG. 8, the electronic apparatus case 100C further has a solar cell module 46 provided on a cover 42. The solar cell module 46 is exposed in each of a first state and a second state. The solar cell module 46 is provided, for example, on an outer surface of the cover 42.

The electronic apparatus case 100C is different from the electronic apparatus case of Embodiment 1 or Embodiment 2 described above in that the solar cell module 46 is further provided. The electronic apparatus case 100C may be the same as the electronic apparatus case of other embodiments except that the solar cell module 46 is further provided.

In the electronic apparatus case 100C, a cover 40 is slid with respect to a holder 20 along a track 44 and is rotated around a rotation axis 22r. Similar to the electronic apparatus case of other embodiments, in the electronic apparatus case 100C, it is possible to perform opening and closing of the cover covering the display of the electronic apparatus compactly and quickly. The electronic apparatus case 100C can deal with Problem 1 described above.

In the electronic apparatus case 100C, the solar cell module 46 is exposed in the first state in which a display surface 10d is covered by the cover 42 and in the second state in which a rear surface 10b (see FIG. 9) on a side opposite to the display surface 10d is covered by the cover 42. Thus, even if the electronic apparatus is used or is not used, it is possible to charge the electronic apparatus. The electronic apparatus case 100C can also deal with Problem 2 described above.

The electronic apparatus case 100C automatically performs charging and discharging without switching charge and discharge by a user. Since the electronic apparatus case 100C does not have, for example, a switch, button, and the like for switching charge and discharge by the user, the user can use the electronic apparatus without considering timing of charging. A cable and a connection device for charging are also not preferable. Among the electronic apparatuses, for devices such as an e-book terminal, an electronic dictionary, and an electronic notebook which are not frequently used by the user, it may be a long time until the next use from a single usage. When using such an electronic apparatus that is not frequently used, if charging is desirable before use, the user gets stressed and a chance to use the electronic apparatus may be further reduced.

The electronic apparatus typically has a battery (secondary battery). As the battery, for example, a lithium ion battery having no memory effect is suitably used. It is known that the life of the battery becomes shorter by over-charging or over-discharging, but if charging is normally performed by the electronic apparatus case of the embodiment, it is possible to suppress over-discharging of the battery. In the electronic devices such as the e-book terminal, the electronic dictionary, and the electronic notebook, since power to be consumed in a single use is not much, the user does not charge the battery whenever using the device. On the other hand, since frequency of charging is less, sometimes the user forgets to charge. In addition, a cable and the like to adapt to the electronic apparatus may be found. If the electronic apparatus case of the embodiment is mounted, for each use, it is possible to use the electronic apparatus while usually replenishing power that is consumed each time. Accordingly, the user is freed from a special operation for charging.

The solar cell module 46 may include a known solar cell. For example, the solar cell module 46 includes a silicon-based (for example, poly silicon solar cell), a compound-based, or an organic-based solar cell. The organic-based solar cell includes a dye-sensitized solar cell. In an indoor environment such as a typical office or home, when the inventors measured illuminance, the illuminance was 500 lux to 600 lux. Therefore, in the electronic apparatus case 100C used for the electronic apparatus that is assumed to be mainly used in an indoor environment, as the solar cell module 46, a dye solar cell generating electricity from light reflected from surrounding objects is employed.

A method for electrically connecting the solar cell module 46 and the electronic apparatus 10 will be described with reference to FIG. 9. The upper left of FIG. 9 is a schematic plan view of the cover 40 of the electronic apparatus case 100C when viewed in a z2 axis direction, the upper right of FIG. 9 is a schematic plan view of the cover 40 of the electronic apparatus case 100C when viewed in a −z2 axis direction, the lower left of FIG. 9 is a schematic plan view of the holder 20 of the electronic apparatus case 100C when viewed in a z1 axis direction, and the lower right of FIG. 9 is a schematic plan view of the holder 20 of the electronic apparatus case 100C when viewed in a −z1 axis direction. The upper left of FIG. 9 represents a surface (that is, an outer surface 42a of the cover 42) on which the solar cell module 46 is provided in surfaces of the cover 40 parallel to an x2-y2 plane and the upper right of FIG. 9 represents a rear surface (that is, an inner surface 42b of the cover 42) of the surface on which the solar cell module 46 is provided in the surface of the cover 40 parallel to an x2-y2 plane. The lower left of FIG. 9 is the plan view of the holder 20 when viewing the holder 20 from the display surface 10d side and the lower right of FIG. 9 is the plan view of the holder 20 when viewing the holder 20 from the rear surface 10b side.

The electronic apparatus case 100C further has, for example, a first terminal 51 which is electrically connected to the solar cell module 46 and a second terminal 52 and a third terminal 53 which are electrically connected to the electronic apparatus 10 held in the holder 20. The second terminal 52 is electrically connected to the first terminal 51 in the first state and the third terminal 53 is electrically connected to the first terminal 51 in the second state.

As illustrated in FIG. 9, the first terminal 51 is provided in, for example, the cover 40 and the second terminal 52 and the third terminal 53 are provided in, for example, the holder 20. As illustrated in FIG. 9, the first terminal 51 is provided in the inner surface 42b of the cover 42. The holder 20 further has, for example, a front member 20a that is provided parallel to the x1-y1 plane and covers portions other than the display in the display surface 10d of the electronic apparatus 10. The second terminal 52 may be provided in the front member 20a. The third terminal 53 may be provided in the rear surface member 20b of the holder 20. In one of the first state and the second state, since the outer surface 42a of the cover 42 having the solar cell module 46 is not covered by the holder 20, the solar cell module 46 is exposed. In the first state, the first terminal 51 is electrically connected to the second terminal 52 by, for example, coming into direct contact with the second terminal 52 and, in the second state, the first terminal 51 is electrically connected to the third terminal 53 by, for example, coming into direct contact with the second terminal 53.

Since the first terminal 51 typically has a convex shape with respect to the inner surface 42b of the cover 42, when rotating the holder 20 with respect to the cover 40, it is preferable that the space between the holder 20 and the cover 40 is wide. It is preferable to provide the space in which the cover 40 can be rotated with respect to the holder 20 without the first terminal 51 coming into contact with the holder 20. If a further wider space is provided, it is possible to rotate the holder 20 more smoothly. For example, it is preferable that the holder 20 has the structure described with reference to FIGS. 5 and 7.

If such a terminal described above is provided, in the process of the transition between the first state and the second state, the solar cell module 46 and the electronic apparatus 10 are not electrically connected and charging of the electronic apparatus 10 or the battery provided in the electronic apparatus is not performed. However, the process of the transition between the first state and the second state is performed in a short period of time and the electronic apparatus 10 equipped with the electronic apparatus case 100C takes the first state or the second state most of the time, and then there is little influence on charging efficiency.

The cover 40 may further have a power storage element (not illustrated). The power storage element includes, for example, a battery (secondary battery) and a capacitor. For example, the electronic apparatus (or the battery provided in the electronic apparatus) is connected from the solar cell module 46 via the power storage element so as to be charged. If the cover 40 has the power storage element, also in the process of the transition between the first state and the second state, it is possible to continuously maintain charging from the solar cell module 46 to the power storage element. Thus, it is possible to efficiently use power generated by the solar cell module 46.

A position and a size of the solar cell module 46 provided on the cover 42 may be arbitrarily set. When using the electronic apparatus case 100C (for example, in the second state) with hands, the position and/or the size of the solar cell module 46 may be adjusted so as not to cover the solar cell module 46 with the hands. If at least a part of the solar cell module 46 is, for example, covered by the hands, an amount of sunlight incident on a portion of the solar cell module 46 covered by the hands is reduced. For example, if the solar cell module 46 is configured of a plurality of solar battery cells connected in series, an output current of the solar battery cell in the solar battery cells, on which the incident light is small, is reduced and thereby an output current of an entire solar cell module 46 is reduced. For example, if the solar cell module 46 is configured of a plurality of solar battery cells connected in parallel, an output voltage of the solar battery cell in the solar battery cells, on which the incident light is small, is reduced and thereby an output voltage of the entire solar cell module 46 is reduced. As described above, if at least a part of the solar cell module 46 is, for example, covered by the hands, the output voltage and/or the output current of the solar cell module 46 may be reduced. It is possible to suppress the reduction by adjusting the position and/or the size of the solar cell module 46.

For example, as illustrated in the upper left of FIG. 9, in the x2-y2 plane of the cover 40, the solar cell module 46 may be provided in a position shifted from a center in the x2 axis direction. The example illustrated in the upper left of FIG. 9 is assumed to hold a lower side in the view with hands. For example, when viewing the cover 40 from the z2 axis direction, a range that does not have the solar cell module 46 in the x2 axis direction is equal to or greater than 20% of the length of the cover 40 in the x2 axis direction. The range is not limited to the example and a space is provided on an upper side or one of right and left sides, and the solar cell module 46 may be provided. For example, when viewing the cover 40 from the z2 axis direction, an area of the solar cell module 46 is equal to or less than 80% of the area of the cover 42.

A method for electrically connecting the solar cell module 46 and the electronic apparatus 10 is not limited to the example described above. An electronic apparatus case 100C1 of Embodiment 3 will be described with reference to FIG. 10. FIG. 10 is a view schematically illustrating the electronic apparatus case 100C1.

The electronic apparatus case 100C1 is different from the electronic apparatus case 100C in that the track 44 has conductivity and also serves as the first terminal 51, and the convex portion 22 or the fitting portion 23 has conductivity and also serves as the second terminal 52 and the third terminal 53. The electronic apparatus case 100C1 may be the same as the electronic apparatus case 100C except for the first to third terminals.

As illustrated in FIG. 10, the track 44 penetrates, for example, in the z2 axis direction. The track 44 is, for example, a rail. The track 44 may not penetrate in the z2 axis direction. A cover covering the track 44 that is the rail may be provided. For example, from a standpoint of suppressing a charging circuit being in an open state by causing foreign matter to adhere the track 44 also serving as the first terminal 51 and the convex portion 22 or the fitting portion 23 also serving as the second and third terminals 52 and 53, it is preferable that the track 44 also serving as the first terminal 51 is not exposed.

FIG. 11 illustrates an example of a configuration of the first to third terminals in the electronic apparatus case 100C1. FIG. 11 is an example of a sectional view in a surface parallel to the x2-z2 plane of the holder 20 and the cover 40 of the electronic apparatus case 100C1. FIG. 11 is an enlarged view of a vicinity of the convex portion 22 and the track 44. As illustrated in FIG. 11, the first terminal 51 provided inside the track 44 comes into direct contact with the terminal (also serving as the second terminal 52 and the third terminal 53) provided in the fitting portion 23 and thereby the solar cell module 46 is electrically connected to the electronic apparatus 10. In the electronic apparatus case 100C1, it is not limited to the first state and the second state and in the process of the transition between both states, these terminals can also come into contact with each other. Accordingly, it is not limited to the first state and the second state, and it is possible to charge the electronic apparatus 10. For example, it is possible to improve electrical connection (contact) between the terminals by providing an elastic body 44s inside the track 44.

### Embodiment 4

An electronic apparatus case 100D of Embodiment 4 according to the disclosure will be described with reference to FIG. 12. FIG. 12 is a view schematically illustrating the electronic apparatus case 100D.

The electronic apparatus case 100D further has an angle adjustment unit 60 which can fix an angle between the z1 axis and the z2 axis to a predetermined angle. The angle adjustment unit 60 is, for example, a stand 60a. The electronic apparatus case 100D is different from the electronic apparatus case of Embodiment 1, Embodiment 2, or Embodiment 3 described above in that the angle adjustment unit 60 is further provided. The electronic apparatus case 100D may be the same as the electronic apparatus case of other embodiments except that the angle adjustment unit 60 is further provided.

In the electronic apparatus case 100D, a cover 40 is slid with respect to a holder 20 along a track 44 and is rotated around a rotation axis 22r. Similar to the electronic apparatus case of other embodiments, in the electronic apparatus case 100D, it is possible to perform opening and closing of the cover covering a display of an electronic apparatus compactly and quickly. The electronic apparatus case 100D can deal with Problem 1 described above.

Since the electronic apparatus case 100D has the angle adjustment unit 60, it is possible to use the electronic apparatus placed on a desk and the like without holding the electronic apparatus with hands. In addition, if the electronic apparatus is used by being placed on a desk, the user can use the electronic apparatus at an angle in which a display surface is easily viewed.

In a case where the electronic apparatus case 100D has a solar cell module 46, it is possible to fix the solar cell module 46 at an angle in which sunlight or illumination light is easily incident by the angle adjustment unit 60. Thus, output power (product of an output voltage and an output current) of the solar cell can increase. The angle adjustment unit 60 may have a structure which can select one angle from a plurality of predetermined angles. As described above, if at least a part of the solar cell module 46 is covered by the hands, there is a problem that an amount of sunlight incident on the solar battery cells configuring the solar cell module 46 is reduced and the output current and/or the output voltage of the solar cell module 46 may be reduced. In order to deal with the problem, the angle of the z1 axis and the z2 axis may be adjusted by the angle adjustment unit 60. If the problem can be dealt with by the adjustment of the angle, it is not preferable to adjust a size and a position of the solar cell module 46, and it is possible to provide the solar cell module 46 in a wide area on the cover 42. Thus, it is possible to improve output power of the solar cells.

As illustrated in FIG. 12, the electronic apparatus case 100D has the stand 60a as the angle adjustment unit 60. For example, a rear surface member 20b of the holder 20 has the stand 60a. For example, in the first state and the second state, in a case where the stand 60a is stored in the rear surface member 20b and the angle between the z1 axis and the z2 axis is fixed to a predetermined angle (for example, an angle of greater than 0° and less than 180°), as illustrated in FIG. 12, the stand 60a becomes a support column between the cover 40 and the holder 20. That is, the angle between the z1 axis and the z2 axis is determined by the cover 40, the holder 20, and the stand 60a. The stand 60a is not limited to the illustrated example and a known stand may be used.

FIG. 13 schematically illustrates an electronic apparatus case 100D1 having a stand 60b as another example of the stand. An upper part of FIG. 13 is an example of a plan view of the electronic apparatus case 100D1 when viewed in the x1 axis direction. Since the x1 axis and the x2 axis are parallel to each other, a plan view of the electronic apparatus case 100D1 when viewed in the x1 axis direction coincides with a plan view of the electronic apparatus case 100D1 when viewed in the x2 axis direction. In FIG. 13, a solar cell module 46 is provided in a cover 40, but the electronic apparatus case 100D1 may not have the solar cell module 46.

In an upper left and the upper right of FIG. 13, in the electronic apparatus case 100D1, angles between the z1 axis and the z2 axis are different from each other. As illustrated in the upper left and the upper right of FIG. 13, the angle between the z1 axis and the z2 axis can be set to a plurality of predetermined angles by the stand 60b. The lower portion of FIG. 13 illustrates an example of an inner surface 42b of a cover 42. For example, as illustrated in the lower left of FIG. 13, the cover 40 has a plurality of concave portions (or convex portions) 61 parallel in the y2 axis direction in the inner surface 42b of the cover 42. The holder 20 is fixed by hooking on any one of these concave portions. The angle between the z1 axis and the z2 axis is determined by selecting any one of the plurality of concave portions (or convex portions) 61. In addition, as illustrated in the lower right of FIG. 13, a sheet-shaped magnet 62 is provided in the inner surface 42b of the cover 42, a magnet (not illustrated) is also provided in a distal end of the holder 20 in the y2 axis direction, and the holder 20 may also be fixed by these magnets. In this case, it is possible to fix the angle between the z1 axis and the z2 axis to an arbitrarily angle of greater than 0° and less than 180°.

An electronic apparatus case 100D2 of Embodiment 4 will be described with reference to FIG. 14. FIG. 14 schematically illustrates the electronic apparatus case 100D2.

As illustrated in FIG. 14, in the electronic apparatus case 100D2, a fitting portion 23 has a gear shape when viewed in the x1 axis direction and also serves as an angle adjustment unit 60. In the electronic apparatus case 100D2, for example, a convex portion engaged with the fitting portion 23 having the gear shape, is provided in a track 44 and thereby it is possible to fix the angle between the z1 axis and the z2 axis to a predetermined angle.

The electronic apparatus case of Embodiment 4 is not limited to the example described above and various mechanisms may be taken as the angle adjustment unit.

The present specification discloses the electronic apparatus case described in the following items 1 to 24.

### Item 1

An electronic apparatus case including a holder that holds an electronic apparatus; and a cover that includes a sheet-shaped cover covering a display surface of the electronic apparatus, in which in the holder, when taking an x1y1z1 orthogonal coordinate system in which a direction that is orthogonal to the display surface of the electronic apparatus and away from the display surface is a z1 axis, a direction that is orthogonal to the z1 axis and parallel to a side of the display surface is a y1 axis, and a direction that is orthogonal to the y1 axis and the z1 axis is an x1 axis, and in the cover, when taking an x2y2z2 orthogonal coordinate system in which a direction that coincides with the x1 axis is an x2 axis, a direction that is orthogonal to the x2 axis and the cover, and away from an inner surface of the cover is a z2 axis, and a direction that is orthogonal to the x2 axis and the z2 axis is a y2 axis, in a first state in which the display surface is covered by the cover, the z1 axis coincides with a −z2 axis. The holder has a pair of side surface members that are provided parallel to a y1-z1 plane and a convex portion that is provided in each of the pair of the side surface members and defines a rotation axis in the x1 axis direction. The cover has a pair of lateral frame members that are provided parallel to a y2-z2 plane and a track that is provided in each of the pair of the lateral frame members, defines a gap extending in the y2 axis direction, and receives the convex portion.

In the electronic apparatus case of Item 1, it is possible to perform opening and closing of the cover covering the display of the electronic apparatus compactly and quickly.

### Item 2

The electronic apparatus case according to Item 1, in which in a second state in which a rear surface on a side opposite to the display surface is covered by the cover, the z1 axis coincides with the z2 axis.

### Item 3

The electronic apparatus case according to Item 1 or 2, in which the cover has the track that is a recessed groove and the gap does not penetrate in the x2 axis direction.

### Item 4

The electronic apparatus case according to Item 1 or 2, in which the pair of the lateral frame members include substantially elliptical-shaped rails and the gap penetrates in the x2 axis direction.

### Item 5

The electronic apparatus case according to any one of Items 1 to 4, in which a length of the cover in the y2 axis direction is shorter than a length of the cover in the x2 axis direction.

In the electronic apparatus case of Item 5, the length of the cover in the y2 axis direction is short and thereby it is possible to increase an effect that opening and closing of the cover covering the display of the electronic apparatus can be performed compactly and quickly.

### Item 6

The electronic apparatus case according to any one of Items 1 to 4, in which a length of the cover in the y2 axis direction is longer than a length of the cover in the x2 axis direction.

### Item 7

The electronic apparatus case according to any one of Items 1 to 6, in which the holder is provided parallel to the x1-y1 plane and further has a rear surface member covering the rear surface.

### Item 8

The electronic apparatus case according to any one of Items 1 to 7, in which in the y1-z1 plane of each of the pair of the side surface members, for a certain point of which a y1 coordinate is positioned between the rotation axis and an end among an end in the y1 axis direction and an end in a −y1 axis direction of the holder, which is close to the rotation axis, a distance from the rotation axis is equal to or less than half a length of the holder in the z1 axis direction.

### Item 9

The electronic apparatus case according to Item 8, in which when viewing the holder in the x1 axis direction, the rotation axis overlaps the electronic apparatus held in the holder and, in each of the pair of the side surface members, the end of the convex portion in the y1 axis direction or the end of the convex portion in the −y1 axis direction coincides with the one end of the holder.

### Item 10

The electronic apparatus case according to Item 8, in which when viewing the holder in the x1 axis direction, the rotation axis does not overlap the electronic apparatus held in the holder.

In the electronic apparatus case of Item 10, when rotating the holder with respect to the cover, since a space between the holder and the cover is wide, it is possible to more smoothly rotate the cover and to perform opening and closing of the cover covering the display of the electronic apparatus more quickly.

### Item 11

The electronic apparatus case according to any one of Items 1 to 10, in which the convex portion has a main portion and a fitting portion that is fitted to the track, and an area of a cross section of the fitting portion parallel to the y1-z1 plane is greater than an area of a cross section of the main portion parallel to the y1-z1 plane.

In the electronic apparatus case of Item 11, it is possible to suppress the convex portion being shifted from the track. Thus, the holder can be more smoothly slid with respect to the cover. Accordingly, it is possible to perform opening and closing of the cover covering the display of the electronic apparatus further quickly.

### Item 12

The electronic apparatus case according to any one of Items 1 to 11, in which a length of the fitting portion in the z1 axis direction substantially coincides with a length of the gap in the z2 axis direction.

### Item 13

The electronic apparatus case according to Item 11 or 12, in which when viewing the holder in the x1 axis direction, the rotation axis overlaps the electronic apparatus held in the holder and, in each of the pair of the side surface members, an end of the fitting portion in the y1 axis direction or an end of the fitting portion in the −y1 axis direction is on the outer side than the one end of the holder.

### Item 14

The electronic apparatus case according to any one of Items 2 to 13, further including a solar cell module that is provided on the cover and is exposed in each of the first state and the second state.

The electronic apparatus case of Item 14 can charge the electronic apparatus even in a case where the electronic apparatus is used and also in a case where the electronic apparatus is not used.

### Item 15

The electronic apparatus case according to Item 14, in which the solar cell module includes a dye-sensitized solar cell.

### Item 16

The electronic apparatus case according to Item 14 or 15, in which when viewing the cover in the z2 axis direction, a range in which the solar cell module is not present in the x2 axis direction is equal to or greater than 20% of the length of the cover in the x2 axis direction.

### Item 17

The electronic apparatus case according to any one of Items 14 to 16, in which when viewing the cover in the z2 axis direction, an area of the solar cell module is equal to or less than 80% of an area of the cover.

### Item 18

The electronic apparatus case according to any one of Items 14 to 17, further including a first terminal that is provided in the cover and is electrically connected to the solar cell module, and a second terminal and a third terminal that are provided in the holder and are electrically connected to the electronic apparatus held in the holder. The second terminal is electrically connected to the first terminal in the first state and the third terminal is electrically connected to the first terminal in the second state.

### Item 19

The electronic apparatus case according to Item 18, in which the first terminal is provided on an outside surface of the cover, the second terminal is provided in a surface member on the display surface side among surface members parallel to an x1-y1 plane provided in the holder, and the third terminal is provided in a surface member on the rear surface side among surface members parallel to an x1-y1 plane provided in the holder.

### Item 20

The electronic apparatus case according to Item 18, in which the track has conductivity and also serves as the first terminal, and the convex portion has conductivity and also serves as the second terminal and the third terminal.

### Item 21

The electronic apparatus case according to any one of Items 1 to 20, further including an angle adjustment unit that can fix an angle between the z1 axis and the z2 axis to a predetermined angle.

### Item 22

The electronic apparatus case according to Item 21, in which the predetermined angle is an arbitrarily angle of greater than 0° and less than 180°.

### Item 23

The electronic apparatus case according to Item 21 or 22, in which the angle adjustment unit is a support column provided in the holder and provided between the cover and the holder at the predetermined angle.

### Item 24

The electronic apparatus case according to Item 21 referring to Item 11, in which the fitting portion is a gear shape when viewed in the x1 axis direction and also serves as the angle adjustment unit.

The disclosure can be widely used as the electronic apparatus case represented by a mobile phone, a smart phone, a tablet PC, a notebook PC, a portable game machine, a music player, an e-book terminal, an electronic dictionary, an electronic notebook, and the like.

The present disclosure contains subject matter related to that disclosed in Japanese Priority Patent Application JP 2015-062557 filed in the Japan Patent Office on Mar. 25, 2015, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus case comprising:
a holder that holds an electronic apparatus; and
a cover that covers a display surface of the electronic apparatus,
wherein in the holder, when taking an x1y1z1 orthogonal coordinate system in which a direction that is orthogonal to the display surface of the electronic apparatus held in the holder and away from the display surface is a z1 axis, a direction that is orthogonal to the z1 axis and parallel to a side of the display surface is a y1 axis, and a direction that is orthogonal to the y1 axis and the z1 axis is an x1 axis, and when taking an x2y2z2 orthogonal coordinate system in which a direction that coincides with the x1 axis is an x2 axis, a direction that is orthogonal to the x2 axis and the cover, and away from an inner surface of the cover is a z2 axis, and a direction that is orthogonal to the x2 axis and the z2 axis is a y2 axis,
in a first state in which the display surface is covered by the cover, the z1 axis coincides with a −z2 axis,
the holder has a pair of side surface members that are provided parallel to a y1-z1 plane and a convex portion that is provided in each of the pair of the side surface members and defines a rotation axis in the x1 axis direction, and
the cover has a pair of lateral frame members that are provided parallel to a y2-z2 plane and a track that is provided in each of the pair of the lateral frame members, defines a gap extending in the y2 axis direction, and receives the convex portion.

2. The electronic apparatus case according to claim 1,
wherein in a second state in which a rear surface on a side opposite to the display surface is covered by the cover, the z1 axis coincides with the z2 axis.

3. The electronic apparatus case according to claim 1,
wherein in the y1-z1 plane of each of the pair of the side surface members, for a certain point of which a y1 coordinate is positioned between the rotation axis and an end among an end in the y1 axis direction and an end in a −y1 axis direction of the holder, which is close to the rotation axis, a distance from the rotation axis is equal to or less than half a length of the holder in the z1 axis direction.

4. The electronic apparatus case according to claim 2, further comprising:
a solar cell module that is provided on the cover and is exposed in each of the first state and the second state.

5. The electronic apparatus case according to claim 4, further comprising:
a first terminal that is provided in the cover and is electrically connected to the solar cell module, and
a second terminal and a third terminal that are provided in the holder and are electrically connected to the electronic apparatus held in the holder,
wherein the second terminal is electrically connected to the first terminal in the first state and the third terminal is electrically connected to the first terminal in the second state.

6. The electronic apparatus case according to claim 3,
wherein when viewing the holder in the x1 axis direction, the rotation axis overlaps the electronic apparatus held in the holder and, in each of the pair of the side surface members, an end of the convex portion in the y1 axis direction or an end of the convex portion in the −y1 axis direction coincides with the one end of the holder.

7. The electronic apparatus case according to claim 1,
wherein the convex portion has a main portion and a fitting portion that is fitted to the track, and an area of a cross section of the fitting portion parallel to the y1-z1 plane is greater than an area of a cross section of the main portion parallel to the y1-z1 plane.

8. The electronic apparatus case according to claim 7,
wherein when viewing the holder in the x1 axis direction, the rotation axis overlaps the electronic apparatus held in the holder and, in each of the pair of the side surface members, an end of the fitting portion in the y1 axis direction or an end of the fitting portion in the −y1 axis direction is on an outer side than the one end of the holder.

9. The electronic apparatus case according to claim 5,
wherein the first terminal is provided on an outside surface of the cover,
wherein the second terminal is provided in a surface member on the display surface side among surface members parallel to an x1-y1 plane provided in the holder and
wherein the third terminal is provided in a surface member on the rear surface side among surface members parallel to an x1-y1 plane provided in the holder.

10. The electronic apparatus case according to claim 5,
wherein the track has conductivity and also serves as the first terminal, and
wherein the convex portion has conductivity and also serves as the second terminal and the third terminal.

11. The electronic apparatus case according to claim 1,
wherein the cover has the track that is a recessed groove and the gap does not penetrate in the x2 axis direction.

12. The electronic apparatus case according to claim 1,
wherein the pair of the lateral frame members include substantially elliptical-shaped rails and the gap penetrates in the x2 axis direction.

13. The electronic apparatus case according to claim 1,
wherein a length of the cover in the y2 axis direction is shorter than a length of the cover in the x2 axis direction.

14. The electronic apparatus case according to claim 1,
wherein a length of the cover in the y2 axis direction is longer than a length of the cover in the x2 axis direction.

15. The electronic apparatus case according to claim 1,
wherein the holder is provided parallel to the x1-y1 plane and further has a rear surface member covering the rear surface.

16. The electronic apparatus case according to claim 4,
wherein the solar cell module includes a dye-sensitized solar cell.

17. The electronic apparatus case according to claim 2,
wherein in the y1-z1 plane of each of the pair of the side surface members, for a certain point of which a y1 coordinate is positioned between the rotation axis and an end among an end in the y1 axis direction and an end in a −y1 axis direction of the holder, which is close to the rotation axis, a distance from the rotation axis is equal to or less than half a length of the holder in the z1 axis direction.

18. The electronic apparatus case according to claim 2,
wherein in the y1-z1 plane of each of the pair of the side surface members, for a certain point of which a y1 coordinate is positioned between the rotation axis and an end among an end in the y1 axis direction and an end in a −y1 axis direction of the holder, which is close to the rotation axis, a distance from the rotation axis is equal to or less than half a length of the holder in the z1 axis direction, and
wherein the electronic apparatus case further comprises:
a solar cell module that is provided on the cover and is exposed in each of the first state and the second state.

19. The electronic apparatus case according to claim 1, further comprising:
an angle adjustment unit that can fix an angle between the z1 axis and the z2 axis to a predetermined angle.

20. The electronic apparatus case according to claim 19,
wherein the angle adjustment unit is a support column provided in the holder and provided between the cover and the holder at the predetermined angle.
